(19) United States
(12) Patent Application Publication
(10) Pub. No.: US 2022/0065149 A1
(43) Pub. Date: Mar. 3, 2022

(54) EXHAUST GAS PURIFICATION SYSTEM WITH AIR INJECTION

(71) Applicant: BASF Corporation, Florham Park, NJ (US)

(72) Inventors: Chun Yu CHEN, Shanghai (CN); Shau Lin CHEN, Shanghai (CN)

(21) Appl. No.: 17/309,961

(22) PCT Filed: Jan. 14, 2020
(86) PCT No.: PCT/CN2020/072056

§ 371 Date: Jul. 6, 2021

(30) Foreign Application Priority Data
Jan. 15, 2019 (CN) PCT/CN2019/071766

(51) Int. Cl. F01N 3/30; F01N 3/10; F01N 3/28; F01N 1/02; B01D 53/94; B01J 23/46; B01J 23/10; B01J 23/889; B01J 23/02; B01J 35/00; B01J 35/04

(52) U.S. Cl. CPC F01N 3/30; B01D 2255/904; F01N 3/106; F01N 3/2803; F01N 1/02; B01D 53/945; B01D 53/9477; B01D 53/944; B01D 53/9454; B01J 23/464; B01J 23/10; B01J 23/8892; B01J 23/02; B01J 35/0006; B01J 35/04; F01N 2370/04; B01D 2255/908; B01D 2255/915; B01D 2255/1023; B01D 2255/1025; B01D 2255/2092; B01D 2255/2063; B01D 2255/2068; B01D 2255/2042; B01D 2255/40; F01N 3/101

(57) ABSTRACT

The present invention relates to an exhaust gas purification system comprising two catalytic sub-systems, wherein the first catalytic sub-system is for conversion of NOx, HC, CO and optionally particulate matter, and the second sub-system is for conversion of CO. The second sub-system locates at the downstream of the first catalytic sub-system. An air injection is positioned between the first catalytic sub-system and second catalytic sub-system.

### TECHNICAL FIELD

The present invention relates to an exhaust gas purification system, comprising two sub-systems and one air injection at the right location, offers a simple yet robust solution to vehicle which has relatively small engine size, and generates ultra-high CO emissions during high speed and/or high load situations, under near wide-open throttle conditions.

### BACKGROUND OF THE INVENTION

For many years, exhaust gas purification system has been applied in the abatement of nitrogen oxide (NOₓ), carbon monoxide (CO), hydrocarbon (HC), particulate matter (PM) and other emissions from internal combustion engines of either gasoline or diesel-fueled engines. Recently, emerging environmental problems such as haze and smog became increasingly challenging especially in developing countries. Stricter emission criteria are already required or will be required in many countries in order to improve the environmental conditions by further limiting emissions such CO, HC, NOₓ and PM etc.

In the United States, on 22 Mar. 2012, the State of California Air Resources Board (CARB) adopted new Exhaust Standards from 2017 and subsequent model year “LEV III” passenger cars, light-duty trucks and medium-duty vehicles which include a 3 mg/mile emission limit, with a later introduction of 1 mg/mi possible, as long as various interim reviews deem it feasible.

Emission legislation in Europe from 1 Sep. 2014 (Euro 6) requires control of the number of particles emitted from both diesel and gasoline (positive ignition) passenger cars. For gasoline EU light duty vehicles, the allowable limits are: 1000 mg/km CO; 60 mg/km NOx; 100 mg/km total hydrocarbons (THC), of which <68 mg/km are non-methane hydrocarbons (NMHC); and 4.5 mg/km PM for direct injection engines only. A particle number (PN) standard limit of 6*10¹¹ km⁻¹ has been set for Euro 6, although an Original Equipment Manufacturer may request a limit of 6*10¹² km⁻¹ until 2017. In a practical sense, the range of particulates that are legislated for are between 23 nm and 3 μm.

On Dec. 23, 2016, the Ministry of Environmental Protection (MEP) of the People's Republic of China published the final legislation for the China 6 limits and measurement methods for emissions from light-duty vehicles (GB18352.6-2016; hereafter referred to as China 6), which is much stricter than the China 5 emission standard. Especially, China 6b targets reductions of THC and CO emissions by 50 percent from China 5 levels, as well as 42 percent reduction of NOx. In addition, China 6b incorporates limits on nitrous oxide (N₂O) and PN, and adopts the on-board diagnostic (OBD) requirements. Furthermore, it is implemented that tests should be tested under World Harmonized Light-duty Vehicle Test Cycle (WLTC).

WLTC includes many steep accelerations and prolong high speed requirements. For vehicle with relative small engine or heavy weight, which demands high power output caused “open-loop” situation (as fuel paddle needs to be pushed all the way down) at extended time (e.g., >5 sec) under rich (air-fuel ratio, A/F<14.65) condition. Excessive CO resulted from these conditions makes emission control difficult. The oxygen storage component in catalysts became insufficient to treat this “A/F rich” condition, regardless of large catalyst volume can be used. One solution is to change calibration to leaner bias to provide more oxygen from air to convert CO. This takes time and subtle balance otherwise “lean NOₓ” issue will emerge, since too much oxygen can compete absorption sites with NO, and retard conversion of NOₓ.

Many of the engines in current vehicles are facing big challenges especially in failing to meet the criteria of emissions of CO, HC, NOₓ and PM etc. Changing the engine design, fuel injection pressure, and/or the advanced engine management system can be employed as potential solutions, however, such solutions are quite complex, costly, and time consuming.

Therefore, it is desirable to develop a simple and cost-effective solution to achieve emission targets and creating cleaner environment.

In 1970s, prior to the invention of TWC, with O₂ sensors and A/F feedback control, many vehicles were calibrated rich calibration and had air injections systems to meet CO/HC standards. However, such air injection system faced difficulty of converting NOₓ due to the competitive absorption of oxygen and NOₓ on precious metal. This system was also regarded not to sufficiently handle PMs from the engines.

U.S. Pat. No. 9,376,949 discloses a selective catalytic reduction (SCR) system for controlling NOx emissions during lean operation on gasoline engines. Such system comprises a light-off catalyst closely coupled to the engine, a SCR catalyst positioned downstream of the light-off catalyst, a reductant introduction system positioned between the light-off catalyst and the SCR catalyst, and an air injection system positioned between the light-off catalyst and the location for reductant injection to inject air into the exhaust stream at designated engine conditions to cool and improve the durability of the SCR catalyst. The addition of air injection is for protecting the SCR catalyst from unfavorable conditions. Such system is for controlling NOx emissions during lean operation on gasoline engines, and it is less able to control CO and PM in the emissions, especially for the exhaust gas of gasoline engines at rich NF conditions.

U.S. Pat. No. 6,477,831 introduces an apparatus contains an electrical heater, a first oxidation catalyst positioned on or downstream of the electrical heater for oxidizing CO and H₂ in the exhaust gas, and a second oxidation catalyst being also the first oxidation catalyst or being positioned downstream thereof for oxidizing HC in the exhaust gas. An air injection is positioned added in the apparatus to increase the amount of CO and H₂ oxidized and hence increase the heat produced chemically by the first oxidation catalyst, whereby to speed up its reaching the HC light-off temperature of the second oxidation catalyst in addition to the electrical heater. However, such solution is less able to control NOₓ and PM in the emissions, especially for the exhaust gas from gasoline engines in a rich A/F condition.

Therefore, to meet current governmental emissions regulations, there is a need for an exhaust gas purification system for exhaust gas from gasoline engines at rich A/F conditions, such system can control the emission of CO, HC, PM, especially the ultra-high CO emissions, and does not negatively impact NOₓ conversion.

### SUMMARY OF THE INVENTION

An object of the present invention is to provide an exhaust gas purification system that can help to remove carbon monoxide (CO), hydrocarbons (HC) and particulate matter (PM) without hurting the conversion of nitrogen oxides (NOx).

A first aspect of the invention relates to an exhaust gas purification system comprising a first catalytic sub-system for conversion of NOx, HC, CO; and optionally PM, a second catalytic sub-system for conversion of CO; and an air injection, wherein the second catalytic sub-system is located downstream of the first catalytic sub-system, the air injection is positioned between the first catalytic sub-system and second catalytic sub-system.

A second aspect of the invention relates to a method for the treatment of exhaust gas from an engine comprising: (i) providing an exhaust treatment system according to first aspect of the invention, and (ii) conducting the exhaust gas from the engine through the exhaust treatment system.

### BRIEF DESCRIPTION OF THE DRAWINGS

FIG. 1 is a schematic view showing exhaust gas purification systems according to one or more embodiments;

FIG. 2 is a schematic view showing exhaust gas purification systems according to one or more embodiments;

### DESCRIPTION OF EMBODIMENTS

Before describing several exemplary embodiments of the invention, it is to be understood that the invention is not limited to the details of construction or process steps set forth in the following description. The invention is capable of other embodiments and of being practiced or being carried out in various ways.

With respect to the terms used in this disclosure, the following definitions are provided.

Throughout the description, including the claims, the term “comprising one” or “comprising a” should be understood as being synonymous with the term “comprising at least one”, unless otherwise specified, and “between” should be understood as being inclusive of the limits.

The terms “a”, “an” and “the” are used to refer to one or to more than one (i.e., to at least one) of the grammatical object of the article.

The term “and/or” includes the meanings “and”, “or” and also all the other possible combinations of the elements connected to this term.

All percentages and ratios are mentioned by weight unless otherwise indicated.

For many years, exhaust gas purification system has been applied in the abatement of nitrogen oxide (NOₓ), carbon monoxide (CO), hydrocarbon (HC), particulate matter (PM) and other emissions from internal combustion engines of either gasoline or diesel-fueled engines. Recently, emerging environmental problems such as haze and smog became increasingly challenging especially in developing countries. Stricter emission criteria are already required or will be required in many countries in order to improve the environmental conditions by further limiting emissions such CO, HC, NOₓ and PM etc.

To meet current governmental emissions regulations, there is a need for an exhaust gas purification system for exhaust gas from gasoline engines at rich air-fuel ratio (A/F) conditions, such system can control the emission of CO, HC, PM, especially the ultra-high CO emissions, and does not negatively impact NOₓ conversion.

Thus, according to embodiments of the invention, provided is an exhaust gas purification system comprising a first catalytic sub-system for conversion of NOx, HC, CO; and optionally PM, a second catalytic sub-system for conversion of CO; and an air injection, wherein the second catalytic sub-system is located downstream of the first catalytic sub-system, the air injection is positioned between the first catalytic sub-system and second catalytic sub-system.

According to any one of the invention embodiments, the exhaust gas purification systems comprise a first catalytic sub-system, a second catalytic sub-system, and an air injection positioned between the first catalytic sub-system and second catalytic sub-system. The second catalytic sub-system is located downstream of the first catalytic sub-system.

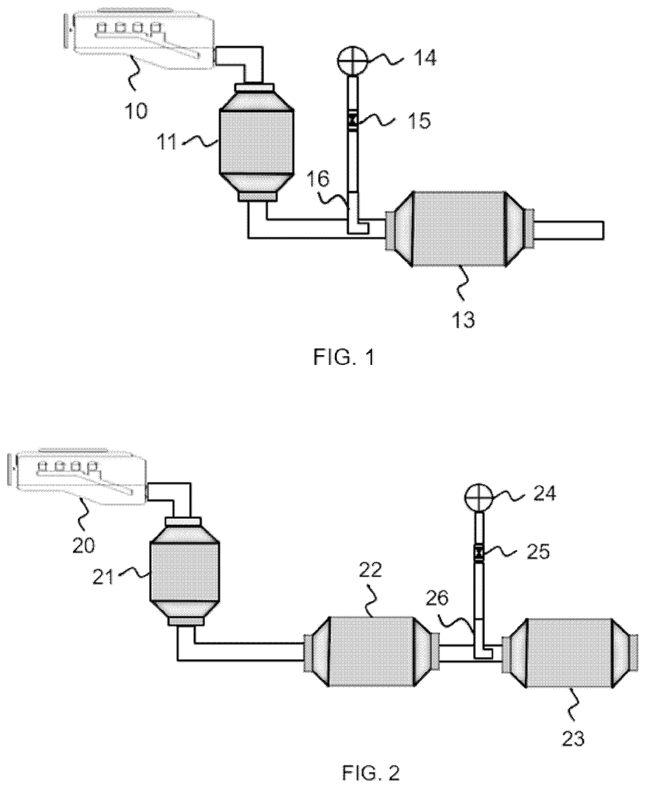

In one or more embodiments, as illustrated in FIG. 1, the first catalytic sub-system comprises a catalyst 11 in close coupled position, the catalyst 11 is selected from the group consisting of TWC catalyst and FWC catalyst; the second catalytic sub-system comprises a catalyst 13 in under floor position, the catalyst 13 is selected from the group consisting of base metal oxide (BMO) catalyst, three-way conversion (TWC) catalyst, and four-way conversion (FWC) catalyst, diesel oxidation catalyst (DOC). The air injection 14 is positioned between catalyst 11 and catalyst 13.

In one or more preferably embodiments, the catalyst 13 is BMO catalyst or DOC.

In one or more embodiments, the catalyst 13 is coated on a carrier selecting from a group consisting of a honeycomb substrate, a foam substrate, and a muffler.

In one or more embodiments, a one-way valve 15 is connected to the air injection 14, the one-way valve 15 locates between the air injection 14 and the catalyst 13. In preferred embodiments, the air injection 14 is controlled by a switch. In more preferred embodiments, the switch is an auto switch controlled by an electronic control unit through a temperature sensor or a wheel speed sensor.

In one or more embodiments, an elbow pipe 16 is connected to the air injection 14, the elbow pipe 16 locates between the air injection 14 and the catalyst 13. Surprisingly, it is found that the use of elbow pipe avoids sacrificing NOx conversion.

In some embodiments, the elbow pipe 16 locates between the one-way valve 15 and the catalyst 13. In alternative embodiments, the one-way valve 15 locates between the elbow pipe 16 and the catalyst 13. In other alternative embodiments, the one-way valve 15 is integrated with the elbow pipe 16.

As used herein, the term “close coupled position” is a position close coupled with engine.

As used herein, the term “under floor position” is a position far away with engine as compared with close coupled position.

As used herein, the term “TWC” refers to a three-way conversion that can substantially eliminate HC, CO and NOₓ from gasoline engine exhaust gases. Typically, a TWC catalyst mainly comprises a platinum group metal (PGM), an oxygen storage component (OSC), and a refractory metal oxide support.

As used herein, the term “platinum group metal” or “PGM” refers to one or more chemical elements defined in the Periodic Table of Elements, including platinum, palladium, rhodium, osmium, iridium, and ruthenium, and mixtures thereof.

In one or more embodiments, the platinum group metal component of the TWC catalyst is selected from platinum, palladium, rhodium, or mixtures thereof. In specific embodiments, the platinum group metal component of the TWC catalyst comprises palladium.

In one or more embodiments, the TWC catalyst does not comprise an additional platinum group metal (i.e., the TWC comprises only one platinum group metal). In other embodiments, the TWC catalyst comprises an additional platinum group metal. In one or more embodiments, when present, the additional platinum group metal is selected from platinum, rhodium, and mixtures thereof. In specific embodiments, the additional platinum group metal component comprises rhodium. In one or more specific embodiments, the TWC catalyst comprises a mixture of palladium and rhodium. In other embodiments, the TWC catalyst comprises a mixture of platinum, palladium, and rhodium.

As used herein, the term “oxygen storage component” (OSC) refers to an entity that has a multi-valence state and can actively react with reductants such as CO or hydrogen under reduction conditions and then react with oxidants such as oxygen or nitrogen oxides under oxidative conditions. Examples of oxygen storage components include rare earth oxides, particularly ceria, lanthana, praseodymia, neodymia, niobia, europia, samaria, ytterbia, yttria, zirconia, and mixtures thereof in addition to ceria. The rare earth oxide may be in bulk (e.g. particulate) form. The oxygen storage component can include ceria in a form that exhibits oxygen storage properties. The lattice oxygen of ceria can react with carbon monoxide, hydrogen, or hydrocarbons under rich NF conditions. In one or more embodiments, the oxygen storage component for the TWC catalyst comprises a ceria-zirconia composite or a rare earth-stabilized ceria-zirconia.

As used herein, the terms “refractory metal oxide support” and “support” refer to underlying high surface area material upon which additional chemical compounds or elements are carried. The support particles have pores larger than 20 A and a wide pore distribution. As defined herein, such supports, e.g., metal oxide supports, exclude molecular sieves, specifically, zeolites. In particular embodiments, high surface area refractory metal oxide supports can be utilized, e.g., alumina support materials, also referred to as “gamma alumina” or “activated alumina,” which typically exhibit a BET surface area in excess of 60 square meters per gram (“m²/g”), often up to about 200 m²/g or higher. Such activated alumina is usually a mixture of the gamma and delta phases of alumina, but may also contain substantial amounts of eta, kappa, and theta alumina phases. Refractory metal oxides other than activated alumina can be used as a support for at least some of the catalytic components in a given catalyst. For example, bulk ceria, zirconia, alpha alumina, silica, titania, and other materials are known for such use.

In one or more embodiments, the refractory metal oxide supports for the TWC catalyst independently comprise a compound that is activated, stabilized, or both, selected from the group consisting of alumina, zirconia, alumina-zirconia, lanthana-alumina, lanthana-zirconia-alumina, alumina-chromia, ceria, alumina-ceria, and combinations thereof.

As used herein, the term “FWC” refers to four-way conversion where in addition to TWC functionality to remove all four pollutants (HC, CO, NOₓ and PM) from gasoline engine exhaust gas. An FWC catalyst mainly comprises a PGM, an OSC, a refractory metal oxide support, and a particulate filter.

As used herein, the term “DOC” refers to diesel oxidation catalysts, which are well-known in the art. Diesel oxidation catalysts are designed to oxidize CO to CO₂ and gas phase HC and an organic fraction of diesel particulates (soluble organic fraction) to CO₂ and H₂O. Typical diesel oxidation catalysts include platinum and optionally also palladium on a high surface area inorganic oxide support, such as alumina, silica-alumina, titania, silica-titania, and a zeolite. As used herein, the term includes a DEC (Diesel Exotherm Catalyst) with creates an exotherm.

As used herein, the term “BMO” refers to base-metal-oxides, which can remove HC, CO from engine exhaust by oxidation reaction. A BMO catalyst mainly comprises a base metal oxide, an OSC, and a refractory metal oxide support. In one or more embodiments, the base metal oxide is selected from the group consisting of manganese oxide, iron oxide, cobalt oxide, copper oxide, zinc oxide, nickel oxide, chromium oxide, silver oxide, and the mixture thereof.

In one or more preferred embodiments, the BMO catalyst comprises Cu—Mn oxides, alumina and Ce—ZrOₓ.

Surprisingly, the use of base metal oxides significantly improves the conversion of CO and does not sacrifice the conversion of NOx.

In one or more embodiments, as illustrated in FIG. 2, the first catalytic sub-system comprises a catalyst 21 in close coupled position, and a catalyst 22 in under floor position; the catalyst 21 and 22 are independently selected from the group consisting of TWC catalyst and FWC catalyst; the second catalytic sub-system comprises a catalyst 23 in under floor position, the catalyst 23 is selected from the group consisting of BMO catalyst, TWC catalyst, and FWC catalyst, DOC. The air injection 24 is positioned between catalyst 22 and catalyst 23. In one or more preferably embodiments, the catalyst 23 is BMO catalyst or DOC.

In one or more embodiments, the catalyst 23 is coated on a carrier selecting from a group consisting of a honeycomb substrate, a foam substrate, and a muffler.

In one or more alternative embodiments, the FWC could be replaced by a particulate filter without washcoat.

In one or more embodiments, a one-way valve 25 is connected to the air injection 24, the one-way valve 25 locates between the air injection 24 and the catalyst 23. In preferred embodiments, the air injection 24 is controlled by a switch. In more preferred embodiments, the switch is an auto switch controlled by an electronic control unit through a temperature sensor or a wheel speed sensor.

In one or more embodiments, an elbow pipe 26 is connected to the air injection 24, the elbow pipe 26 locates between the air injection 24 and the catalyst 23. Surprisingly, it is found that the use of elbow pipe avoids sacrificing NOx conversion.

In some embodiments, the elbow pipe 26 locates between the one-way valve 25 and the catalyst 23. In alternative embodiments, the one-way valve 25 locates between the elbow pipe 26 and the catalyst 23. In other alternative embodiments, the one-way valve 25 is integrated with the elbow pipe 26.

The test method in the present invention is World Harmonized Light-duty Vehicle Test Cycle (WLTC) evaluation on chassis dyno according to Limits and measurement methods for emissions from light-duty vehicles (China 6) (GB 18352.6-2016) for category-I vehicle based on China 6b requirements, wherein the emission limits for non-methane hydrocarbons (NMHC), total hydrocarbons (THC), CO, NOx and particle numbers (PN) are 35 mg/km, 50 mg/km, 500 mg/km, 35 mg/km and 6*10¹¹ km⁻¹ respectively.

In one or more embodiments, the wheel speed sensor and/or the temperature sensor are applied to control the working time of the air injection. It was found that working at phase 4 of WLTC which is the extra high-speed phase of the engine, already can fulfil the goal of the invention since lots of CO emission come out at phase-4 of WLTC. When the speed is low and the bed temperature is not high, the CO emission is not very bad; while the engine is working faster and faster and the speed exceeds 20 kilometers per hour (“km/h”), especially when the speed is more than 40 km/h, 60 km/h or 80 km/h, an air injection can be very helpful in abatement of CO emission. In general, the higher the engine speed, the higher the bed temperature. Therefore, having the air injected only when the engine is speeding up more than certain valve can be implemented by applying a wheel speed sensor and/or a temperature sensor to an auto switch of the air injection to have the air injection only work during certain speed, such as above 20 km/h, preferably above 40 km/h, more preferably above 60 km/h, and most preferably above 80 km/h, and/or certain temperature, such as above 200° C., preferably 300 to 950° C., and more preferably 400 to 800° C., most preferably 500 to 700° C. in the exhaust pipe.

In one or more embodiments, the second catalytic sub-system is composed of a muffler coated with catalytic material or washcoat, or a catalytic converter also served as sound quenching device. Such embodiments can be performed by a normal muffler function unit that is engineered as an acoustic device to reduce the loudness of the sound pressure created from the engine by acoustic quieting, plus a catalytic converter function unit that is reducing emission of excessive CO with O₂ from the injected air.

The simple but efficient solution of the present invention enable current vehicles with China 5 calibrations to pass China 6 criteria without extensive more than twenty months' re-calibration and foreseeable much larger cost.

### EXAMPLES

The present invention is more fully illustrated by the following examples, which are set forth to illustrate the present invention and is not to be construed as limiting thereof. Unless otherwise noted, all parts and percentages are by weight, and all weight percentages are expressed on a dry basis, meaning excluding water content, unless otherwise indicated.

In all examples of this invention, the emission of CO is significantly reduced than the comparative examples. The examples with right position of air injection and comprising FWC in the first catalytic sub-system shows both reduced emission of CO and PM without hurting the conversion of NOx. The main reason is the inventive way of use of the air injection in the exhaust gas purification system and incorporation of the FWC in the exhaust gas purification system.

### Exhaust Gas Purification Systems with an Air Injection

### Example 1

As shown in FIG. 2, an exhaust gas purification system was prepared, the first catalytic sub-system had a catalyst 21 in close coupled position, and a catalyst 22 in under floor position; the catalyst 21 was a TWC catalyst with 4.1 g/in³ of total washcoat containing 1.6% of Pd, 0.2% of Rh, 65% of OSC, 29% of Al₂O₃, 0.7% of La₂O₃, 0.5% of Nd₂O₃ and 3% of BaO; the catalyst 22 was a TWC catalyst with 4.2 g/in³ of total washcoat containing 0.2% of Pd, 0.2% of Rh, 70% of OSC, 24% of Al₂O₃, 1% of Nd₂O₃ and 4.6% of BaO; the second catalytic sub-system had a catalyst 23 in under floor position, the catalyst 23 was a TWC catalyst with 4.2 g/in³ of total washcoat containing 0.2% of Pd, 0.2% of Rh, 70% of OSC, 24% of Al₂O₃, 1% of Nd₂O₃ and 4.6% of BaO. The air injection 24 is positioned between catalyst 22 and catalyst 23 via a one-way valve 25. and the air was injected during the whole WLTC. The test result indicated 33 mg/km of NMHC, 38 mg/km of THC, 540 mg/km of CO, 44 mg/km of NOₓ and 1.55*10¹² km⁻¹ of PN emissions.

### Example 2

As shown in FIG. 2, an exhaust gas purification system was prepared, the first catalytic sub-system had a catalyst 21 in close coupled position, and a catalyst 22 in under floor position; the catalyst 21 was a TWC catalyst with 4.1 g/in³ of total washcoat containing 1.6% of Pd, 0.2% of Rh, 65% of OSC, 29% of Al₂O₃, 0.7% of La₂O₃, 0.5% of Nd₂O₃ and 3% of Ba0; the catalyst 22 was a TWC catalyst with 4.2 g/in³ of total washcoat containing 0.2% of Pd, 0.2% of Rh, 70% of OSC, 24% of Al₂O₃, 1% of Nd₂O₃ and 4.6% of BaO; the second catalytic sub-system had a catalyst 23 in under floor position, the catalyst 23 was a BMO catalyst with 2.9 g/in³ of total washcoat containing 55% of Al₂O₃, 30% of OSC and 15% of Cu—Mn oxides. The air injection 24 is positioned between catalyst 22 and catalyst 23 via a one-way valve 25, and the air was injected during the whole WLTC. The test result indicated 33 mg/km of NMHC, 39 mg/km of THC, 440 mg/km of CO, 40 mg/km of NOₓ and 1.42*10¹² km⁻¹ of PN emissions.

### Example 3

An exhaust gas purification system was prepared as Example 2, the only difference was the air injection 24 was directing to catalyst 23 by using an elbow pipe 26. The test result indicated 33 mg/km of NMHC, 39 mg/km of THC, 480 mg/km of CO, 34 mg/km of NOx and 1.49*10¹² km⁻¹ of PN emissions.

### Example 4

An exhaust gas purification system was prepared as Example 3, the only difference was the air was injected during phase-4 of WLTC only. The test result indicated 26 mg/km of NMHC, 30 mg/km of THC, 450 mg/km of CO, 30 mg/km of NOx and 1.45*10¹² km⁻¹ of PN emissions.

### Example 5

An exhaust gas purification system was prepared as Example 4, the differences were the air injection 24 is positioned between catalyst 21 and catalyst 22, the air injection 24 was directing to catalyst 22 by using an elbow pipe 26. The test result indicated 27 mg/km of NMHC, 31 mg/km of THC, 200 mg/km of CO, 35 mg/km of NOx and 1.71*10¹² km⁻¹ of PN emissions.

### Example 6

An exhaust gas purification system was prepared as Example 4. The difference was the catalyst 22 was an FWC with 1.0 g/in³ of total washcoat containing 0.2% of Pd, 0.2% of Rh, 70% of OSC, 25% of Al₂O₃ and 4.6% of BaO, and a particulate filter. The test result indicated 27 mg/km of NMHC, 30 mg/km of THC, 380 mg/km of CO, 29 mg/km of NOx and 5.61*10¹¹ km⁻¹ of PN emissions.

### Example 7

An exhaust gas purification system was prepared as Example 5, the only difference was the catalyst 22 was an FWC with 1.0 g/in³ of total washcoat containing 0.2% of Pd, 0.2% of Rh, 70% of OSC, 25% of Al₂O₃, and 4.6% of BaO, and a particulate filter. The test result indicated 27 mg/km of NMHC, 31 mg/km of THC, 430 mg/km of CO, 45 mg/km of NOx and 4.14*10¹¹ km⁻¹ of PN emissions.

### Comparative Example 1

A typical China 5 exhaust gas purification system was prepared, the exhaust gas purification system had a first catalyst in close coupled position, and a second catalyst in under floor position; the first catalyst was a TWC catalyst with 4.1 g/in³ of total washcoat containing 1.6% of Pd, 0.2% of Rh, 65% of OSC, 29% of Al₂O₃, 0.7% of La₂O₃, 0.5% of Nd₂O₃ and 3% of BaO; the second catalyst was a TWC catalyst with 4.2 g/in³ of total washcoat containing 0.2% of Pd, 0.2% of Rh, 70% of OSC, 24% of Al₂O₃, 1% of Nd₂O₃ and 4.6% of BaO. No air injection was involved in the system. The test result indicated 39 mg/km of NM HC, 46 mg/km of THC, 1440 mg/km of CO, 27 mg/km of NOx and 1.88*10¹² km⁻¹ of PN emissions.

### Comparative Example 2

As shown in FIG. 2, an exhaust gas purification system was prepared, the first catalytic sub-system had a catalyst 21 in close coupled position, and a catalyst 22 in under floor position; the catalyst 21 was a TWC catalyst with 4.1 g/in³ of total washcoat containing 1.6% of Pd, 0.2% of Rh, 65% of OSC, 29% of Al₂O₃, 0.7% of La₂O₃, 0.5% of Nd₂O₃ and 3% of BaO; the catalyst 22 was a TWC catalyst with 4.2 g/in³ of total washcoat containing 0.2% of Pd, 0.2% of Rh, 70% of OSC, 24% of Al₂O₃, 1% of Nd₂O₃ and 4.6% of BaO; the second catalytic sub-system had a catalyst 23 in under floor position, the catalyst 23 was a TWC catalyst with 4.2 g/in³ of total washcoat containing 0.2% of Pd, 0.2% of Rh, 70% of OSC, 24% of Al₂O₃, 1% of Nd₂O₃ and 4.6% of BaO. No air injection was involved in the system. The test result indicated 36 mg/km of NMHC, 43 mg/km of THC, 1070 mg/km of CO, 21 mg/km of NOx and 1.90*10¹² km⁻¹ of PN emissions.

### Comparative Example 3

An exhaust gas purification system was prepared as Comparative Example 2. The difference was the catalyst 22 was a BMO catalyst with 2.9 g/in³ of total washcoat containing 55% of Al₂O₃, 30% of OSC and 15% of Cu—Mn oxides. The test result indicated 32 mg/km of NMHC, 36 mg/km of THC, 1090 mg/km of CO, 28 mg/km of NOx and 1.78*10¹² km⁻¹ of PN emissions.

The detailed data has proven a major improvement in conversion of CO and PM without hurting the conversion of HC and NOₓ.

Table 1 summarized the test results according to the emission of Examples.

TABLE 1

| | | | | | PN |
|---|---|---|---|---|---|
| | NMHC | THC | CO | NOx | (10¹¹ |
| Example | (mg/km) | (mg/km) | (mg/km) | (mg/km) | km⁻¹) |
| Example 1 | 33 | 38 | 540 | 44 | 15.5 |
| Example 2 | 33 | 39 | 440 | 40 | 14.2 |
| Example 3 | 33 | 39 | 480 | 34 | 14.9 |
| Example 4 | 26 | 30 | 450 | 30 | 14.5 |
| Example 5 | 27 | 31 | 200 | 35 | 17.1 |
| Example 6 | 27 | 30 | 380 | 29 | 5.61 |
| Example 7 | 27 | 31 | 430 | 45 | 4.14 |
| Comparative | 39 | 46 | 1440 | 27 | 18.8 |
| Example 1 | | | | | |
| Comparative | 36 | 43 | 1070 | 21 | 19.0 |
| Example 2 | | | | | |
| Comparative | 32 | 36 | 1090 | 28 | 17.8 |
| Example3 | | | | | |

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. An exhaust gas purification system comprising:
a first catalytic sub-system for conversion of nitrogen oxides (NOx), hydrocarbons (HC), carbon monoxide (CO), and optionally particulate matter (PM);
a second catalytic sub-system for conversion of CO; and
an air injection;
wherein the second catalytic sub-system is located downstream of the first catalytic sub-system, and the air injection is positioned between the first catalytic sub-system and second catalytic sub-system.

2. The exhaust gas purification system according to claim 1, wherein the second catalytic sub-system comprises one or more catalysts chosen from base metal oxide (BMO) catalyst, three-way conversion (TWC) catalyst, four-way conversion (FWC) catalyst, and diesel oxidation catalyst (DOC).

3. The exhaust gas purification system according to claim 1, wherein the first catalytic sub-system comprises one or both catalysts chosen from TWC catalyst and FWC catalyst.

4. The exhaust gas purification system according to claim 3, wherein the first catalytic sub-system comprises a TWC catalyst in close coupled position, and a FWC catalyst in an under floor position, wherein the second catalytic sub-system comprises a BMO catalyst or a DOC.

5. The exhaust gas purification system according to claim 4, wherein the BMO catalyst or the DOC is coated on a carrier chosen from a honeycomb substrate, a foam substrate, and a muffler.

6. The exhaust gas purification system according to claim 2, wherein the TWC catalyst comprises a platinum group metal (PGM), an oxygen storage component (OSC), and a refractory metal oxide support; and
the FWC comprises a platinum group metal (PGM), an oxygen storage component (OSC), a refractory metal oxide support, and a particulate filter.

7. The exhaust gas purification system according to claim 2, wherein the BMO catalyst comprises a base metal oxide, an oxygen storage component (OSC), and a refractory metal oxide support.

8. The exhaust gas purification system according to claim 7, wherein the base metal oxide is chosen from manganese oxide, iron oxide, cobalt oxide, copper oxide, zinc oxide, nickel oxide, chromium oxide, silver oxide, and mixtures thereof.

9. The exhaust gas purification system according to claim 2, wherein the DOC comprises a platinum group metal (PGM), and a high surface area inorganic oxide support.

10. The exhaust gas purification system according to claim 1, wherein a one-way valve is connected to the air injection, and the one-way valve locates between the air injection and the second catalytic sub-system.

11. The exhaust gas purification system according to claim 1, wherein the air injection is connected to the second catalytic sub-system through an elbow pipe.

12. The exhaust gas purification system according to claim 1, wherein the air injection is controlled by an auto switch controlled by an electronic control unit through a temperature sensor or wheel speed sensor.

13. A method for treating exhaust gas from an engine comprising:
(i) providing an exhaust treatment system according to claim 1; and
(ii) conducting the exhaust gas from the engine through the exhaust treatment system.

14. The method according to claim 13, wherein the exhaust gas comprises hydrocarbons, carbon monoxide, nitrogen oxides, and particulate matter.
